(19) United States
(12) Patent Application Publication
(10) Pub. No.: US 2024/0089858 A1
(43) Pub. Date: Mar. 14, 2024

(54) METHOD AND DEVICE FOR POWER SAVING OPERATION IN COMMUNICATION SYSTEM SUPPORTING MULTIPLE LINKS

(71) Applicants: HYUNDAI MOTOR COMPANY, Seoul (KR); KIA CORPORATION, Seoul (KR); Korea National University of Transportation Industry-Academic Cooperation Foundation, Chungju-si (KR)

(72) Inventor: Yong Ho Kim, Incheon (KR)

(73) Assignees: HYUNDAI MOTOR COMPANY, Seoul (KR); KIA CORPORATION, Seoul (KR); Korea National University of Transportation Industry-Academic Cooperation Foundation, Chungju-si (KR)

(21) Appl. No.: 18/513,997

(22) Filed: Nov. 20, 2023

Related U.S. Application Data
(63) Continuation-in-part of application No. PCT/KR2022/007347, filed on May 24, 2022.

(30) Foreign Application Priority Data
May 31, 2021 (KR) 10-2021-0070265

(51) Int. Cl. H04W 52/02

(52) U.S. Cl. CPC H04W 52/0235

(57) ABSTRACT

A method and device for a power saving operation in a communication system supporting multiple links includes a method of a first device including the steps of performing a PS setting procedure with a second device; generating a first frame including a first data unit, for initiating a transmission operation according to the PS setting procedure; and transmitting the first frame to the second device in a first link mapped to the first data unit among multiple links set between the first device and the second device.

### CROSS-REFERENCE TO RELATED APPLICATION

The present application is a continuation-in-part of currently pending International Patent Application No. PCT/KR 2022/007347, filed May 24, 2022, which claims priority to Korean Patent Application No. 10-2021-0070265, filed May 31, 2021, the entire contents of which are incorporated herein for all purposes by these references.

### BACKGROUND OF THE PRESENT DISCLOSURE

### Field of the Present Disclosure

The present disclosure relates to a wireless local area network (LAN) communication technique, and more particularly, to a technique for frame transmission and reception in a device supporting a low-power (e.g., power saving) operation on a multi-link.

### Description of Related Art

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

The standards using the wireless LAN technology are being standardized as IEEE802.11 standards mainly in the Institute of Electrical and Electronics Engineers (IEEE). As the above-described wireless LAN technologies have been developed and spread, applications using the wireless LAN technologies have been diversified, and a demand for a wireless LAN technology supporting a higher throughput has arisen. Accordingly, a frequency bandwidth (e.g., ‘maximum 160 MHz bandwidth’ or ‘80+80 MHz bandwidth’) used in the IEEE 802.11ac standard has been expanded, and the number of supported spatial streams has also increased. The IEEE 802.11ac standard may be a very high throughput (VHT) wireless LAN technology supporting a high throughput of 1 gigabit per second (Gbps) or more. The IEEE 802.1 lac standard can support downlink transmission for multiple stations by utilizing the MIMO techniques.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

However, since multi-link operations are operations not defined in the existing wireless LAN standard, it may be necessary to define detailed operations according to an environment in which the multi-link operations are performed. In particular, when a low-power operation is performed in a communication system supporting a multi-link, a transmission operation and/or reception operation may not be performed due to a link on which downlink communication is performed. When the low-power operation is performed based on an unscheduled-automatic power save delivery (U-APSD) scheme, if a user priority (UP) or access category (AC) configured for uplink is different from a UP or AC configured for downlink, a transmission and reception operation of data frames through the multi-link may not be performed. In this reason, a low-power operation method considering the multi-link may be required.

Meanwhile, the technologies that are the background of the present disclosure are written to improve the understanding of the background of the present disclosure and may include content that is not already known to those of ordinary skill in the art to which the present disclosure belongs.

### BRIEF SUMMARY

Various aspects of the present disclosure are directed to providing a method and an apparatus for data frame transmission and reception when a low-power operation is performed in a communication system supporting a multi-link.

A method of a first device, according to various exemplary embodiments of the present disclosure for achieving the above-described objective, may include: performing a power saving (PS) configuration procedure with a second device; generating a first frame including a first data unit to initiate a transmission operation according to the PS configuration procedure; and transmitting the first frame to the second device on a first link of a multi-link configured between the first device and the second device, the first link being mapped to the first data unit.

The method may further include: performing a mapping procedure of traffic identifier (TID)-to-link mapping with the second device, wherein a first access category (AC) of the first data unit is mapped to a first TID, and the first link is determined based on a mapping relationship between the first AC and the first TID and a relationship of the TID-to-link mapping.

The first device may include a plurality of stations (STAs), and a state of a first STA operating on the first link among the plurality of STAs may transition from a doze state to a wake-up state for transmission of the first frame.

The first frame may be a quality of service (QoS) data frame that serves as an unscheduled-automatic power save delivery (U-APSD) trigger frame.

A duration field included in the first frame may indicate a time including a time required for transmission and reception of a reception response frame for the first frame and a time required for transmission and reception of a second data frame including information indicating a second AC of a second data unit present in the second device.

The information may be a bitmap, and each bit included in the bitmap may indicate presence or absence of a data unit associated with an AC.

The method may further include: receiving the second frame from the second device on the first link; and identifying a second link of the multi-link, which is mapped to the second AC indicated by the second frame, wherein a state of a second STA operating on the second link among the plurality of STAs included in the first device transitions from a doze state to a wake-up state after a time of receiving the second frame.

The method may further include: receiving a third frame including the second data unit from the second device on the second link, wherein a reception operation of the third frame is performed within a U-APSD service period (SP) that starts after the time of receiving the second frame.

A U-APSD SP for the first link or a U-APSD SP for the multi-link may start at a time of transmitting the first frame.

States of a plurality of STAs included in the first device supporting the multi-link may transition from a doze state to a wake-up state at a time at which the U-APSD SP for the multi-link starts.

The method may further include: generating a fourth frame including a third data unit to initiate a transmission operation according to the PS configuration procedure; and transmitting the fourth frame to the second device on a third link of the multi-link, the third link being mapped to the third data unit.

The first link and the third link may be available links excluding busy link(s) of the multi-link.

A first device, according to various exemplary embodiments of the present disclosure for achieving the above-described objective, may include: a processor; and a memory configured for storing one or more instructions executable by the processor, and the one or more instructions may be executed to perform: performing a power saving (PS) configuration procedure with a second device; generating a first frame including a first data unit to initiate a transmission operation according to the PS configuration procedure; and transmitting the first frame to the second device on a first link of a multi-link configured between the first device and the second device, the first link being mapped to the first data unit.

The one or more instructions may be further executed to perform: performing a mapping procedure of traffic identifier (TID)-to-link mapping with the second device, wherein a first access category (AC) of the first data unit is mapped to a first TID, and the first link is determined based on a mapping relationship between the first AC and the first TID and a relationship of the TID-to-link mapping.

The first device may include a plurality of stations (STAs), and a state of a first STA operating on the first link among the plurality of STAs may transition from a doze state to a wake-up state for transmission of the first frame.

A duration field included in the first frame may indicate a time including a time required for transmission and reception of a reception response frame for the first frame and a time required for transmission and reception of a second data frame including information indicating a second AC of a second data unit present in the second device.

The one or more instructions may be further executed to perform: receiving the second frame from the second device on the first link; and identifying a second link of the multi-link, which is mapped to the second AC indicated by the second frame, wherein a state of a second STA operating on the second link among the plurality of STAs included in the first device transitions from a doze state to a wake-up state after a time of receiving the second frame.

A U-APSD SP for the first link or a U-APSD SP for the multi-link may start at a time of transmitting the first frame.

States of a plurality of STAs included in the first device supporting the multi-link may transition from a doze state to a wake-up state at a time at which the U-APSD SP for the multi-link starts.

The one or more instructions may be further executed to perform: generating a fourth frame including a third data unit to initiate a transmission operation according to the PS configuration procedure; and transmitting the fourth frame to the second device on a third link of the multi-link, the third link being mapped to the third data unit, wherein the first link and the third link are available links excluding busy link(s) of the multi-link.

According to an exemplary embodiment of the present disclosure, a low-power operation in a communication system can be performed based on the U-APSD scheme. Communication between devices (e.g., station, access point) may be performed using a multi-link. An operating state of a station may transition to a normal state on one link of the multi-link, and the station operating in the normal state may transmit a data frame. An access point may transmit and receive frames using the multi-link regardless of the type of data to be transmitted to the station. Accordingly, the low-power operation can be performed efficiently.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating various exemplary embodiments of a communication node constituting a wireless LAN system.

FIG. 2 is a timing diagram illustrating various exemplary embodiments of a U-APSD low-power operation.

FIG. 3 is a timing diagram illustrating various exemplary embodiments of a U-APSD low-power operation on a multi-link.

FIG. 4 is a timing diagram illustrating various exemplary embodiments of a U-APSD low-power operation on a multi-link.

FIG. 5 is a timing diagram illustrating various exemplary embodiments of a U-APSD low-power operation on a multi-link.

FIG. 6 is a timing diagram illustrating various exemplary embodiments of a U-APSD low-power operation on a multi-link.

It may be understood that the appended drawings are not necessarily to scale, presenting a somewhat simplified representation of various features illustrative of the basic principles of the present disclosure. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the present disclosure, to facilitate the entire understanding of the present disclosure, like numbers refer to like elements throughout the description of the figures and the repetitive description thereof will be omitted.

In the following, a wireless communication system to which exemplary embodiments according to an exemplary embodiment of the present disclosure are applied will be described. The wireless communication system to which the exemplary embodiments according to an exemplary embodiment of the present disclosure are applied is not limited to the contents described below, and the exemplary embodiments according to an exemplary embodiment of the present disclosure can be applied to various wireless communication systems. A wireless communication system may be referred to as a ‘wireless communication network’.

In exemplary embodiments, ‘configuration of an operation (e.g., transmission operation)’ may mean that ‘configuration information (e.g., information element(s), parameter(s)) for the operation’ and/or ‘information indicating to perform the operation’ is signaled. ‘Configuration of an information element (e.g., parameter)’ may mean that the information element is signaled. ‘Configuration of a resource (e.g., resource region)’ may mean that setting information of the resource is signaled.

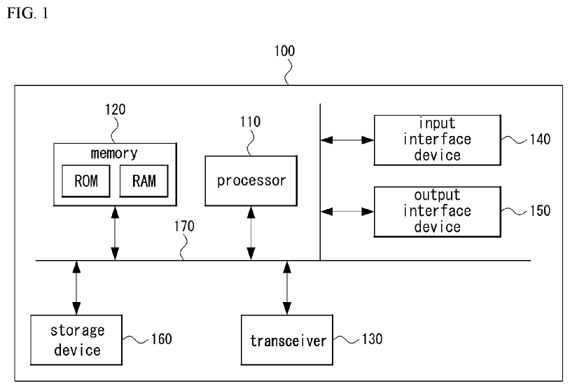

FIG. 1 is a block diagram illustrating a first exemplary embodiment of a communication node constituting a wireless LAN system.

As shown in FIG. 1, a communication node 100 may be an access point, a station, an access point (AP) multi-link device (MLD), or a non-AP MLD. An access point may refer to ‘AP’, and a station may refer to ‘STA’ or ‘non-AP STA’. An operating channel width supported by an AP may be 20 megahertz (MHz), 80 MHz, 160 MHz, or the like. An operating channel width supported by a STA may be 20 MHz, 80 MHz, or the like.

The communication node 100 may include at least one processor 110, a memory 120, and a transceiver 130 connected to a network to perform communications. The transceiver 130 may be referred to as a transceiver, a radio frequency (RF) unit, an RF module, or the like. In addition, the communication node 100 may further include an input interface device 140, an output interface device 150, a storage device 160, and the like. The respective components included in the communication node 100 may be connected by a bus 170 to communicate with each other.

However, the respective components included in the communication node 100 may be connected through individual interfaces or individual buses centering on the processor 110 instead of the common bus 170. For example, the processor 110 may be connected to at least one of the memory 120, the transceiver 130, the input interface device 140, the output interface device 150, and the storage device 160 through a dedicated interface.

The processor 110 may execute program commands stored in at least one of the memory 120 and the storage device 160. The processor 110 may refer to a central processing unit (CPU), a graphics processing unit (GPU), or a dedicated processor on which the methods according to the exemplary embodiments of the present invention are performed. Each of the memory 120 and the storage device 160 may be configured as at least one of a volatile storage medium and a nonvolatile storage medium. For example, the memory 120 may be configured with at least one of a read only memory (ROM) and a random access memory (RAM).

A low-power operation may be performed in a communication system (e.g., a communication system supporting a multi-link). The low-power operation may mean a power-saving operation. The low-power operation may be performed based on an unscheduled-automatic power save delivery (U-APSD) scheme or a scheduled (S)-APSD scheme. The low-power operation based on the U-APSD scheme may be referred to as ‘U-APSD low-power operation’, and the low-power operation based on the S-APSD scheme may be referred to as ‘S-APSD low-power operation’.

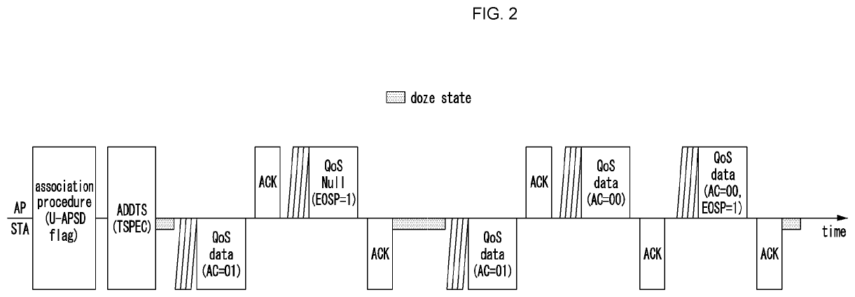

FIG. 2 is a timing diagram illustrating a first exemplary embodiment of a U-APSD low-power operation.

As shown in FIG. 2, an AP and a STA may negotiate U-APSD parameter(s) through an association procedure. In the association procedure, an association request frame and an association response frame may be transmitted and received. In exemplary embodiments, an association frame may refer to an association request frame and/or an association response frame. The association frame may include a U-APSD flag field, and the U-APSD flag field may be used to configure access category(ies) (AC(s)) that support the U-APSD low-power operation. The size of the U-APSD flag field may be four bits, and each bit thereof may correspond to one AC. For example, the four bits included in the U-APSD flag field may be an AC_VO U-APSD flag, AC_VI U-APSD flag, AC_BK U-APSD flag, and AC_BE U-APSD flag, respectively.

When a bit included in the U-APSD flag field is set to a first value (e.g., 0), this may mean that an AC corresponding to the bit is neither a trigger-enabled AC nor delivery-enabled AC. That is, the bit set to the first value in the U-APSD flag field may indicate that a trigger-enabled scheme and a delivery-enabled scheme are not used. When a bit included in the U-APSD flag field is set to a second value (e.g., 1), this may mean that an AC corresponding to the bit is a trigger-enabled AC and a delivery-enabled AC. That is, the bit set to the second value in the U-APSD flag field may indicate that the trigger-enabled scheme and the delivery-enabled scheme are used.

When the trigger-enabled scheme is used, the AP may transmit a data frame to the STA after receiving a U-APSD trigger frame from the STA. The U-APSD trigger frame may be a quality of service (QoS) data frame or QoS Null data frame. The QoS Null data frame may be a QoS data-type frame, and the payload size of the QoS Null data frame may be 0. That is, the QoS Null data frame may not include data and may perform a function of delivering information (e.g., end of service period (EOSP), traffic identifier (TID)) through a MAC header. An AC may be configured with (e.g., mapped to) a TID. Therefore, an AC of the frame may be indicated through a TID.

When the delivery-enabled scheme is used and a buffered data (BU), which is data to be transmitted to the STA, exists in the AP, the AP may configure a traffic indication map (TIM) indicating an association identifier (AID) of the STA that is to receive the BU, and broadcast the TIM. The STA may receive the TIM from the AP, and if the AID indicated by the TIM is equal to its AID, the STA may transmit a power saving (PS)-Poll frame to the AP to receive the BU. The PS-Poll frame may indicate that the STA operates in a normal state (e.g., wake-up state). The AP may receive the PS-Poll frame from the STA and determine that the STA is operating in the normal state based on the PS-Poll frame. The AP may transmit a data frame including the BU to the STA by performing a channel access operation.

When a bit included in the U-APSD flag field is set to 1, both the trigger-enabled scheme and the delivery-enabled scheme may be used. Therefore, if a BU to be transmitted to the STA exists in the AP, the AP may use the TIM to indicate that the BU to be transmitted to the STA exists. The STA may receive the TIM from the AP, and may identify that the BU for the STA exists in the AP based on the TIM. In the instant case, the STA may transmit a U-APSD trigger frame or PS-Poll frame to the AP. An AP multi-link device (MLD) that supports a multi-link may inform a link mapped to the TID of the BU indicated by the TIM. A STA MLD (or non-AP MLD) that supports a multi-link may obtain information on the link on which the BU indicated in the TIM is to be received, and operate in the normal state to receive the BU on the link.

The AP and the STA may configure a U-APSD through a traffic specification (TPSEC) configuration procedure. When the TSPEC configuration procedure is initiated by the STA, the STA may transmit an add traffic stream (ADDTS) request frame, which is an action frame, to the AP and receive an ADDTS response frame from the AP. A TSPEC may be configured by the above-described operations. When the TSPEC configuration procedure is initiated by the AP, the AP may transmit an ADDTS reserve request frame, which is an action frame, to the STA and receive an ADDTS reserve response frame from the STA. A TSPEC may be configured by the above-described operations.

The frames used to configure a TSPEC (e.g., ADDTS request frame, ADDTS response frame, ADDTS reserve request frame, ADDTS reserve response frame) may include a TSPEC element. The TSPEC element may include traffic stream (TS) information, and the U-APSD may be configured using the TS information. The TS information may include direction information indicating a transmission direction (e.g., uplink or downlink). The direction information set to ‘00’ may indicate uplink (UL), the direction information set to ‘10’ may indicate downlink (DL), and the direction information set to ‘11’ may indicate bi-directional link (e.g., uplink and downlink).

The AC supported in the U-APSD low-power operation may be specified by configuring a user priority (UP) according to the direction information. The size of UP (e.g., UP field) may be three bits, and the UP may indicate one value from 0 to 7. A mapping relationship between UP and AC may be defined as shown in Table 1 below.

TABLE 1

| UP value | AC |
|---|---|
| 0 | AC_BE |
| 1 | AC_BK |
| 2 | AC_BK |
| 3 | AC_BE |
| 4 | AC_VI |
| 5 | AC_VI |
| 6 | AC_VO |
| 7 | AC_VO |

The U-APSD configured in the TSPEC configuration procedure may take precedence over a U-APSD configured in the association procedure. That is, the U-APSD configured in the association procedure may be replaced with the U-APSD configured in the TSPEC configuration procedure after the association procedure. When the U-APSD is configured, the STA may transmit a U-APSD trigger frame to initiate a transmission operation according to the U-APSD low-power operation. When a data unit to be transmitted exists in the STA, and an AC of the data unit is mapped to the U-APSD, the STA may transmit a QoS data frame or QoS Null frame, which is a U-APSD trigger frame. The QoS data frame may perform a role (e.g., function) of a U-APSD trigger frame. The AC mapped to the U-APSD may be the AC supported in the U-APSD low-power operation. In exemplary embodiments, the data unit may be a buffered data (BU), a medium access control (MAC) protocol data unit (MPDU), or a physical layer protocol data unit (PPDU).

The U-APSD trigger frame may be transmitted on one or more links among links to which the TID of the data frame (or AC of the data unit) is mapped. Information (e.g., mapping relationship) of TID-to-link mapping may be configured in advance, and the link(s) on which the U-APSD trigger frame is transmitted may be identified based on the information of TID-to-link mapping. A mapping procedure of TID-to-link mapping may be performed in advance between the AP MLD and the STA MLD. For example, the mapping procedure of TID-to-link mapping may be performed in a multi-link setup procedure and/or association procedure. A single link may be used even when TID-to-link mapping is not used or it is not mapped by TID-to-link mapping.

When the U-APSD trigger frame is received from the STA, if there is a BU to be transmitted to the STA, the AP may transmit a data frame including the BU to the STA. If a BU to be transmitted to the STA does not exist in the AP, the AP may set an end of service period (EOSP) included in a QoS Null frame to 1, and transmit the QoS Null frame to the STA. Alternatively, if the BU to be transmitted is the last BU of a service period (SP), the AP may set an EOSP included in a QoS data frame to 1 to terminate the U-APSD SP, and transmit the QoS data frame. The U-APSD SP may refer to a time during which the STA operates in a wake-up state (e.g., normal state).

The U-APSD SP may be a period from a time at which the STA transmits the U-APSD trigger frame to a time at which the STA transmits an ACK frame for the QoS Null frame (e.g., QoS Null frame including the EOSP set to 1) received from the AP. Alternatively, the U-APSD SP may be a period from a time at which the STA transmits the U-APSD trigger frame to a time at which the STA transmits an ACK frame for the BU (e.g., data frame) received from the AP as long as the length of MAX SP (or, the number of BUs transmittable within MAX SP) negotiated in the U-APSD configuration procedure. The communication node (e.g., AP MLD, STA MLD, AP, STA) may perform the U-APSD low-power operation by repeatedly performing the above-described procedures.

In the exemplary embodiment of FIG. 2, when a data unit (e.g., data frame) with AC=01 exists in the STA, the STA may generate a QoS data frame with AC=01, and transmit the QoS data frame or a QoS Null frame, which is a U-APSD trigger A frame. That is, the QoS data frame or QoS Null frame may perform a role (e.g., function) of a U-APSD trigger frame.

The AP may receive the QoS data frame (e.g., U-APSD trigger frame) from the STA. If a BU to be transmitted to the STA does not exist in the AP, the AP may set an EOSP of a QoS Null frame to 1 and terminate the U-APSD SP by transmitting the QoS Null frame to the STA. When a data unit (e.g., data frame) with AC=01 occurs again in the STA, the STA may generate a QoS data frame with AC=01, and transmit the QoS data frame or a QoS Null frame, which is a U-APSD trigger frame. The AP may receive the QoS data frame (e.g., U-APSD trigger frame) from the STA. If a BU (e.g., data unit with AC=00) to be transmitted to the STA exists in the AP, the AP may transmit a QoS data frame with AC=00 to the STA. The transmission operation of the BU may be performed multiple times within the length of MAX SP negotiated between the AP and STA. The EOSP included in the last QoS data frame within the MAX SP may be set to 1. The U-APSD SP may be terminated due to transmission of the QoS data frame including the EOSP set to 1.

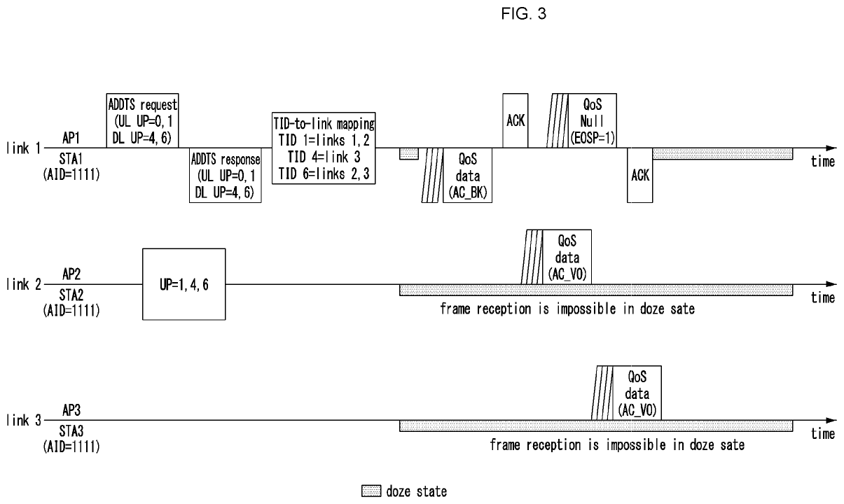

FIG. 3 is a timing diagram illustrating a first exemplary embodiment of a U-APSD low-power operation on a multi-link.

As shown in FIG. 3, an MLD may have one medium access control (MAC) address that identifies the MLD. In exemplary embodiments, an MLD may refer to an AP MLD and/or a non-AP MLD. The MAC address of the MLD may be used in a multi-link setup procedure between AP MLD and non-AP MLD. The MAC address of the AP MLD may be different from the MAC address of the non-AP MLD. AP(s) affiliated with the AP MLD may have different MAC addresses, and STA(s) affiliated with the non-AP MLD may have different MAC addresses. Within the AP MLD, each of the APs with different MAC addresses may be in charge of one link, and may perform a role of an AP on each link. Within the non-AP MLD, each of the STAs with different MAC addresses may be in charge of one link, and may perform a role of a STA on each link. The non-AP MLD may also be referred to as ‘STA MLD’. In the exemplary embodiment of FIG. 3, an AP1, AP2, and AP3 may be APs affiliated with the AP MLD, and a STA1, STA2, and STA3 may be STAs affiliated with the STA MLD.

The AP MLD and the STA MLD may perform an association procedure on one link of a multi-link. The AP MLD and the STA MLD may perform a multi-link setup procedure on one link of the multi-link. Links supported between the AP MLD and the STA MLD may be negotiated through the multi-link setup procedure. Therefore, communication using the multi-link may be performed between the AP MLD and the STA MLD.

The AP MLD and the STA MLD may perform a TSPEC configuration procedure including U-APSD configuration on one link of the multi-link. The TSPEC configuration procedure may be performed through transmission and reception of an ADDTS request frame, ADDTS reserve request frame, ADDTS response frame, and/or ADDTS reserve response frame including a TSPEC element. The TSPEC configuration procedure (e.g., U-APSD configuration procedure) may mean a power saving (PS) configuration procedure. In the exemplary embodiment of FIG. 3, a UL UP set (e.g., mapped) to 0 (AC_BE), UL UP set (e.g., mapped) to 1 (AC_BK), DL UP set (e.g., mapped) to 4 (AC_VI), and DL UP set (e.g., mapped) to 6 (AC_VO) may be configured. The UL UP set to 0 (AC_BE), UL UP set to 1 (AC_BK), DL UP set to 4 (AC_VI), and DL UP set to 6 (AC_VO) may be configured as being supported in the U-APSD low-power operation. The mapping relationship between UP and AC may be as shown in Table 1, and the values of TID (e.g., 0 to 7) may be the same as the values of UP (e.g., 0 to 7). The mapping relationship between the values of TID and ACs may be the same as the mapping relationship between UP and AC defined in Table 1. Alternatively, the values of TID may be set differently from the values of UP. For example, the TIDs and the ACs may be mapped differently from the values of UP.

The AP MLD and the STA MLD may perform a TID-to-link mapping procedure on one link of the multi-link. In the TID-to-link mapping procedure, link(s) negotiated in the multi-link setup procedure may be mapped to a specific TID. Since the TID is mapped to the AC, when a specific TID is mapped to a specific link, it may be determined through which link a data unit with which AC is transmitted and received. In the exemplary embodiment of FIG. 3, a TID 1 (AC_BK) may be mapped to links 1 and 2, a TID 4 (AC_VI) may be mapped to a link 3, and a TID 6 (AC_VO) may be mapped to the links 2 and 3. A TID 0 (AC_BE), which is not mapped to a link, may be implicitly interpreted as being mapped to all links. In other words, a TID 0 (AC_BE) may be automatically mapped to all links without a separate configuration procedure.

When the U-APSD configuration procedure (e.g., PS configuration procedure, TSPEC configuration procedure) is completed between the AP MLD and the STA MLD, the STA(s) affiliated with the STA MLD may operate in a doze state (e.g., sleep state). Alternatively, when the TID-to-link mapping procedure between the AP MLD and the STA MLD is completed, the STA(s) affiliated with the STA MLD may operate in a doze state. To transmit a frame, an operating state of the STA on each link may transition from the doze state to the wake-up state. When the U-APSD low-power operation is configured, the STA MLD may transmit a U-APSD trigger frame to initiate a transmission operation according to the U-APSD low-power operation. When the STA MLD has a data unit to transmit, and an AC of the data unit is mapped to U-APSD, the STA MLD may transmit a QoS data frame or QoS Null frame which is a U-APSD trigger frame. That is, the QoS data frame or QoS Null frame may perform a role (e.g., function) of a U-APSD trigger frame. The U-APSD trigger frame may be transmitted on one or more links among links to which the TID of the data frame (e.g., data unit) is mapped. In the exemplary embodiment of FIG. 3, the AC of the data unit may be AC_BK, AC_BK may be associated (e.g., mapped) to the TID 1, and the TID 1 may be mapped to the links 1 and 2. That is, AC_BK may be mapped to the links 1 and 2.

The STA MLD may select the link 1 among the links (e.g., link 1 and link 2) mapped to AC_BK, and transmit a QoS data frame of AC_BK, which is a U-APSD trigger frame. The AP1 may receive the U-APSD frame (e.g., QoS data frame of AC_BK) from the STA1 on the link 1. An AC_VO BU, a data unit to be transmitted to the STA MLD affiliated with the STA1, may exist in the AP MLD affiliated with the AP1. AC_VO may be associated with a TID 6, and the TID 6 may be mapped to the links 2 and 3. Therefore, the AP MLD may transmit data frame(s) of AC_VO using the link 2 and/or link 3. That is, the AP2 may transmit a QoS data frame of AC_VO on the link 2, and AP3 may transmit a QoS data frame of AC_VO on the link 3.

Since a BU corresponding to the TID mapped to the link 1 does not exist in the AP MLD (e.g., AP1), the AP1 may transmit a QoS Null frame including an EOSP set to 1 on the link 1. Since the STA MLD does not know which BU the AP MLD has, it may operate in the doze state on link(s) other than the link on which the U-APSD trigger frame (e.g., QoS data frame) is transmitted. For example, when the U-APSD trigger frame (e.g., QoS data frame) is transmitted on the link 1 of the multi-link, the STA1 of the STA MLD may operate in a wake-up state on the link 1, the STA2 of the STA MLD may operate in the doze state on the link 2, and the STA3 of the STA MLD may operate in the doze state on the link 3. The doze state may mean a low-power state or a power-saving state. The STA(s) (e.g., STA2 and/or STA3) operating in the doze state may not receive the data frame(s) (e.g., QoS data frame(s) of AC_VO) from the AP.

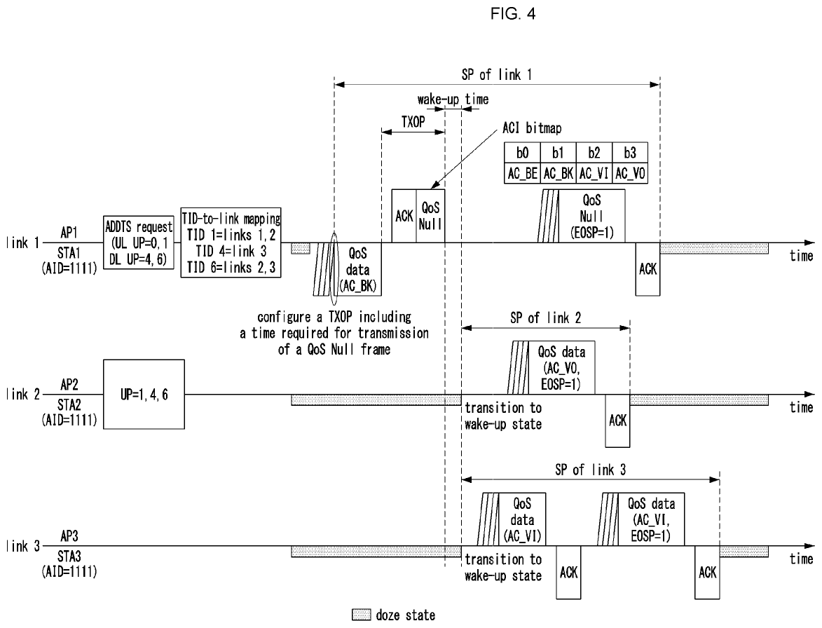

FIG. 4 is a timing diagram illustrating a second exemplary embodiment of a U-APSD low-power operation on a multi-link.

As shown in FIG. 4, an AP MLD and a STA MLD may perform an association procedure on one link of a multi-link. The AP MLD and the STA MLD may perform a multi-link setup procedure on one link of a multi-link. Links supported between the AP MLD and the STA MLD may be negotiated through the multi-link setup procedure. Therefore, communication using a multi-link may be performed between the AP MLD and the STA MLD.

The AP MLD and the STA MLD may perform a TSPEC configuration procedure including U-APSD configuration on one link of the multi-link. The TSPEC configuration procedure may be performed through transmission and reception of an ADDTS request frame, ADDTS reserve request frame, ADDTS response frame, and/or ADDTS reserve response frame including a TSPEC element. In the exemplary embodiment of FIG. 4, a UL UP set (e.g., mapped) to 0 (AC_BE), UL UP set (e.g., mapped) to 1 (AC_BK), DL UP set (e.g., mapped) to 4 (AC_VI), and DL UP set (e.g., mapped) to 6 (AC_VO) may be configured. The UL UP set to 0 (AC_BE), UL UP set to 1 (AC_BK), DL UP set to 4 (AC_VI), and DL UP set to 6 (AC_VO) may be configured as being supported in the U-APSD low-power operation. The mapping relationship between UP and AC may be as shown in Table 1, and the values of TID (e.g., 0 to 7) may be the same as the values of UP (e.g., 0 to 7). The mapping relationship between the values of TID and ACs may be the same as the mapping relationship between UP and AC defined in Table 1. Alternatively, the values of TID may be set differently from the values of UP. For example, the TIDs and the ACs may be mapped differently from the values of UP.

The AP MLD and the STA MLD may perform a TID-to-link mapping procedure on one link of the multi-link. In the TID-to-link mapping procedure, link(s) negotiated in the multi-link setup procedure may be mapped to a specific TID. Since TIDs are mapped to ACs, when a specific TID is mapped to a specific link, it may be determined through which link a data unit with which AC is transmitted and received. In the exemplary embodiment of FIG. 4, a TID 1 (AC_BK) may be mapped to links 1 and 2, a TID 4 (AC_VI) may be mapped to a link 3, and a TID 6 (AC_VO) may be mapped to the links 2 and 3. A TID 0 (AC_BE), which is not mapped to a link, may be implicitly interpreted as being mapped to all links. In other words, a TID 0 (AC_BE) may be automatically mapped to all links without a separate configuration procedure.

When a U-APSD low-power operation is configured, the STA MLD may transmit a U-APSD trigger frame to initiate a transmission operation according to the U-APSD low-power operation. When the STA MLD has a data unit to transmit, and an AC of the data unit is mapped to U-APSD, the STA MLD may transmit a QoS data frame or QoS Null frame that is a U-APSD trigger frame. That is, the QoS data frame or QoS Null frame may perform a role (e.g., function) of a U-APSD trigger frame. The U-APSD trigger frame may be transmitted on one or more links among links to which a TID of the data unit is mapped. In the exemplary embodiment of FIG. 4, the AC of the data unit may be AC_BK, AC_BK may be associated with the TID 1, and the TID 1 may be mapped to the links 1 and 2. That is, AC_BK may be mapped to the links 1 and 2.

The STA MLD may select the link 1 among the links (e.g., link 1 and link 2) mapped to AC_BK, and may transmit a QoS data frame of AC_BK, which is a U-APSD trigger frame, on the link 1. The APT may receive a U-APSD frame (e.g., QoS data frame of AC_BK) from the STAT on the link 1.

The STA MLD may not know which AC's BU(s) the AP MLD has. Therefore, the STAT of the STA MLD may request the AP MLD to inform the ACs that the AP MLD has through a reception response frame to the U-APSD trigger frame. To support the above-described operation, a transmit opportunity (TXOP) configured by the U-APSD trigger frame (e.g., QoS data frame) that is transmitted by the STAT of the STA MLD on the link 1 may include a time required for the AP1 of the AP MLD to transmit a QoS Null frame including information of ACs of the BU(s). In order to configure the above-described TXOP, a time indicated by a duration field included in a MAC header of the QoS data frame transmitted by the STAT may be configured to include a time required for transmission of the QoS Null frame of the APT. For example, the time indicated by the duration field included in the MAC header of the QoS data frame transmitted by the STAT may include a time required for transmission/reception of a reception response frame for the QoS data frame and a time required for transmission/reception of the QoS Null frame including information of ACs of the BU(s) present in the AP MLD.

The APT may receive the QoS data frame (e.g., U-APSD trigger frame) from the STAT and identify the time indicated by the duration field included in the MAC header of the QoS data frame. If the time indicated by the duration field included in the QoS data frame is longer than a time required for transmission of the reception response frame (e.g., ACK frame or BA frame) for the corresponding QoS data frame, the APT may determine that the QoS data frame indicates transmission of the QoS Null frame including information of the ACs of the BU(s). In the instant case, the APT may transmit the QoS Null frame including information of the ACs of the BU(s) present in the AP MLD to the STAT together with the reception response frame (e.g., ACK frame or block Acknowledgement (BA) frame). The reception response frame and the QoS Null frame transmitted from the APT to the STAT may be transmitted in a form of an aggregated (A)-MPDU. Alternatively, the reception response frame and the QoS Null frame transmitted from the APT to the STAT may be transmitted with an interval of an SIFS. An A-control field included in a MAC header of the QoS Null frame may be used to indicate information of the AC(s) (or TID(s)) of the BU(s) waiting for transmission in the AP MLD.

In the A-control field, the conventional BSR may be used as is. Alternatively, a new control ID (e.g., 7) may be used. For example, the A-control field included in the QoS data frame or QoS Null frame transmitted by the AP MLD to indicate the presence or absence of a BU for each AC to the AP MLD may include a BSR. If the control ID is 7, the QoS Null frame or QoS data frame including an access category index (ACI) bitmap with a size of four bits may be transmitted. The ACI bitmap may include four bits (e.g., b0, b1, b2, b3). In the ACI bitmap, b0 may indicate whether a BU of AC_BE exists, b1 may indicate whether a BU of AC_BK exists, b2 may indicate whether a BU of AC_VI exists, and b3 may indicate whether a BU of AC_VO exists. A bit set to a first value (e.g., 0) in the ACI bitmap may indicate that a BU of an AC corresponding to the bit does not exist. A bit set to a second value (e.g., 1) in the ACI bitmap may indicate that a BU of an AC corresponding to the bit exists. When the BSR is used as is, the QoS Null frame may include information indicating the size of data after the ACI bitmap.

In the exemplary embodiment of FIG. 4, the APT may transmit the QoS Null frame including the A-control field indicating information of the BU(s) (e.g., information of AC(s) or TID(s) of the BU(s)) together with the reception response frame for the QoS data frame received from the STAT. When a BU of AC_VI and a BU of AC_VO exist in the AP MLD, the AP MLD (e.g., AP1) may set the values of b2 and b3 in the ACI bitmap to 1, and transmit the QoS Null frame including the A-control field indicating the ACI bitmap.

The STAT may receive the reception response frame and the QoS Null frame from the AP1, and may identify information of the ACs of the BU(s) based on the A-control field (e.g., ACI bitmap) included in the QoS Null frame. For example, the STA MLD (e.g., STA1) may determine that a BU of AC_VI and a BU of AC_VO exist in the AP MLD. The STA MLD may identify link(s) to which AC_VI and AC_VO are mapped based on the TID-to-link mapping relationship, and operate in the normal state on the identified link(s) (e.g., transition from the doze state to the wake-up state). On the link 3 to which AC_VI is mapped, the operating state of the STA3 may transition from the doze state to the normal state (e.g., wake-up state), and the STA3 operating in the normal state may receive a QoS data frame including the BU of AC_VI from the AP3. On the links 2 and 3 to which AC_VO is mapped, the operating states of the STA2 and the STA3 may transition from the doze state to the normal state (e.g., wake-up state). The operating state of each of the STA2 and the STA3 may transition from the doze state to the normal state after a time of receiving the QoS Null frame or after a wake-up time from the time of receiving the QoS Null frame. The wake-up time may be same or longer than a time required for transition from the doze state to the wake-up state. The wake-up time may be a preset time. The STA2 operating in the normal state may receive the QoS data frame including the BU of AC_VO from the AP2, and the STA3 operating in the normal state may receive the QoS data frame including the BU of AC_VO from the AP3.

The AP2 and the AP3 of the AP MLD may transmit the data frames (e.g., QoS data frame of AC_VO, QoS data frame of AC_VI), respectively, after a preset time (e.g., wake-up time) from a time of transmitting the QoS Null frame. When the STAT transmits a reception response frame (e.g., ACK or BA frame) for the QoS Null frame received along with the reception response frame from the AP1, the STA1 may transmit the reception response frame for the QoS Null frame after a SIFS elapses from the time of receiving the QoS Null frame. In the instant case, the AP2 and the AP3 may each transmit the data frame (e.g., QoS data frame of AC_VO, QoS data frame of AC_VI) after receiving the above-described reception response frame without waiting for a preset time (e.g., wake-up time).

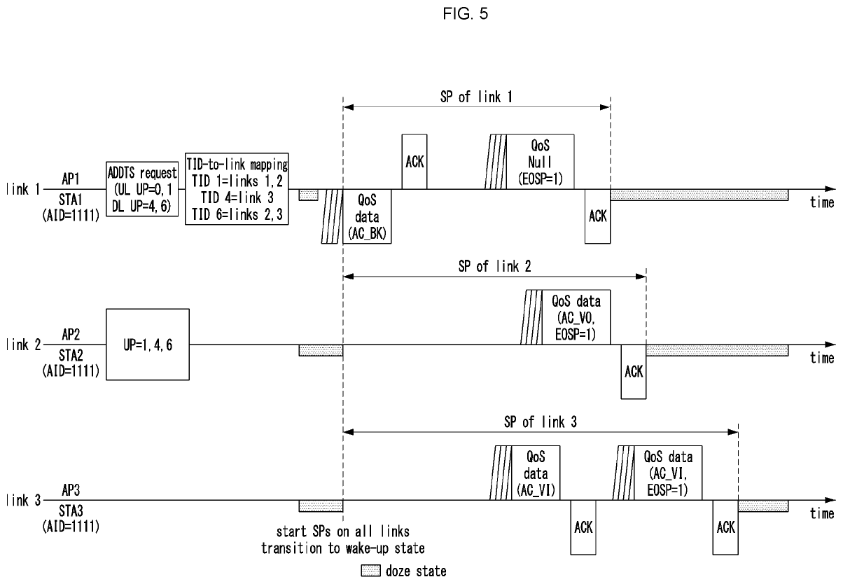

FIG. 5 is a timing diagram illustrating a third exemplary embodiment of a U-APSD low-power operation on a multi-link.

As shown in FIG. 5, an AP MLD and a STA MLD may perform an association procedure on one link of a multi-link. The AP MLD and the STA MLD may perform a multi-link setup procedure on one link of a multi-link. Links supported between the AP MLD and the STA MLD may be negotiated through the multi-link setup procedure. Therefore, communication using a multi-link may be performed between the AP MLD and the STA MLD.

The AP MLD and the STA MLD may perform a TSPEC configuration procedure including U-APSD configuring on one link of the multi-link. The TSPEC configuration procedure may be performed through transmission and reception of an ADDTS request frame, ADDTS reserve request frame, ADDTS response frame, and/or ADDTS reserve response frame including a TSPEC element. In the exemplary embodiment of FIG. 5, a UL UP set (e.g., mapped) to 0 (AC_BE), UL UP set (e.g., mapped) to 1 (AC_BK), DL UP set (e.g., mapped) to 4 (AC_VI), and DL UP set (e.g., mapped) to 6 (AC_VO) may be configured. The UL UP set to 0 (AC_BE), UL UP set to 1 (AC_BK), DL UP set to 4 (AC_VI), and DL UP set to 6 (AC_VO) may be configured as being supported in the U-APSD low-power operation. The mapping relationship between UP and AC may be as shown in Table 1, and the values of TID (e.g., 0 to 7) may be the same as the values of UP (e.g., 0 to 7). The mapping relationship between the values of TID and ACs may be the same as the mapping relationship between UP and AC defined in Table 1. Alternatively, the values of TID may be set differently from the values of UP. For example, the TIDs and the ACs may be mapped differently from the values of UP.

The AP MLD and the STA MLD may perform a TID-to-link mapping procedure on one link of the multi-link. In the TID-to-link mapping procedure, link(s) negotiated in the multi-link setup procedure may be mapped to a specific TID. Since TIDs are mapped to ACs, when a specific TID is mapped to a specific link, it may be determined through which link a data unit with which AC is transmitted and received. In the exemplary embodiment of FIG. 5, a TID 1 (AC_BK) may be mapped to links 1 and 2, a TID 4 (AC_VI) may be mapped to a link 3, and a TID 6 (AC_VO) may be mapped to the links 2 and 3. A TID 0 (AC_BE), which is not mapped to a link, may be implicitly interpreted as being mapped to all links. In other words, a TID 0 (AC_BE) may be automatically mapped to all links without a separate configuration procedure.

When a U-APSD low-power operation is configured, the STA MLD may transmit a U-APSD trigger frame to initiate a transmission operation according to the U-APSD low-power operation. When the STA MLD has a data unit to transmit, and an AC of the data unit is mapped to U-APSD, the STA MLD may transmit a QoS data frame or QoS Null frame that is a U-APSD trigger frame. That is, the QoS data frame or QoS Null frame may perform a role (e.g., function) of a U-APSD trigger frame. The U-APSD trigger frame may be transmitted on one or more links among links to which a TID of the data unit is mapped. In the exemplary embodiment of FIG. 5, the AC of the data unit may be AC_BK, AC_BK may be associated with the TID 1, and the TID 1 may be mapped to the links 1 and 2. That is, AC_BK may be mapped to the links 1 and 2.

The STA MLD may select the link 1 among the links (e.g., link 1 and link 2) mapped to AC_BK, and may transmit a QoS data frame of AC_BK, which is a U-APSD trigger frame, on the link 1. The APT may receive a U-APSD frame (e.g., QoS data frame of AC_BK) from the STAT on the link 1.

The STA MLD may not know which AC's BU the AP MLD has. Therefore, when the STAT of the STA MLD transmits the QoS data frame, which is a U-APSD trigger frame, on the link 1, the operating state of the STA may transition to the normal state (e.g., wake-up state) on each of all links supported by the STA MLD or all links configured to use U-APSD. On each link, an SP (e.g., U-APSD SP) may start from a time of transmitting the first U-APSD trigger frame. When a data frame including an EOSP set to 1 is received or when BU(s) as long as the length of MAX SP (or as many BU(s) as the number of BUs transmittable within MAX SP) are received, the SP may be terminated on each link.

In the exemplary embodiment of FIG. 5, the STA1 may transmit a QoS data frame or QoS Null frame, which is a U-APSD trigger frame, on the link 1. On each of the links supported by the STA MLD affiliated with the STA1, the operating state of the STA may transition to the normal state (e.g., wake-up state) at a time of transmitting the QoS data frame. On each link, an SP (e.g., U-APSD SP) may start from the time of transmitting the QoS data frame (or a time when the STA's operating state transitions to the normal state). When there is no downlink BU on the link 1 (e.g., when a BU to be transmitted to the STA1 does not exist in AP1), the AP1 may transmit a QoS Null frame including an EOSP set to 1. The STA1 may receive the QoS Null frame from the AP1, and may terminate the SP on the link 1 when the EOSP included in the QoS Null frame is set to 1. On the link 1, the SP may be terminated after transmission of a reception response frame (e.g., ACK frame or BA frame) for the QoS data frame or QoS Null frame including the EOSP set to 1.

The AP2 may transmit a QoS data frame including a BU of AC_VO on the link 2. An EOSP included in the QoS data frame transmitted on the link 2 may be set to 1. The STA2 may receive the QoS data frame from the AP2 and identify the BU of AC_VO and the EOSP included in the QoS data frame. Since the EOSP included in the QoS data frame is set to 1, the STA2 may terminate the SP on the link 2. On the link 2, the SP may be terminated after transmission of a reception response frame for the QoS data frame including the EOSP set to 1.

The AP3 may generate QoS data frame(s) including a BU of AC_VI on the link 3 and transmit two QoS data frames. An EOSP included in the first QoS data frame may be set to 0, and an EOSP included in the second QoS data frame may be set to 1. The STA3 may receive the two QoS data frames from the AP3. Since the EOSP included in the second QoS data frame is set to 1, the STA3 may terminate the SP on the link 3. On the link 3, the SP may be terminated after transmission of a reception response frame for the second QoS data frame including the EOSP set to 1.

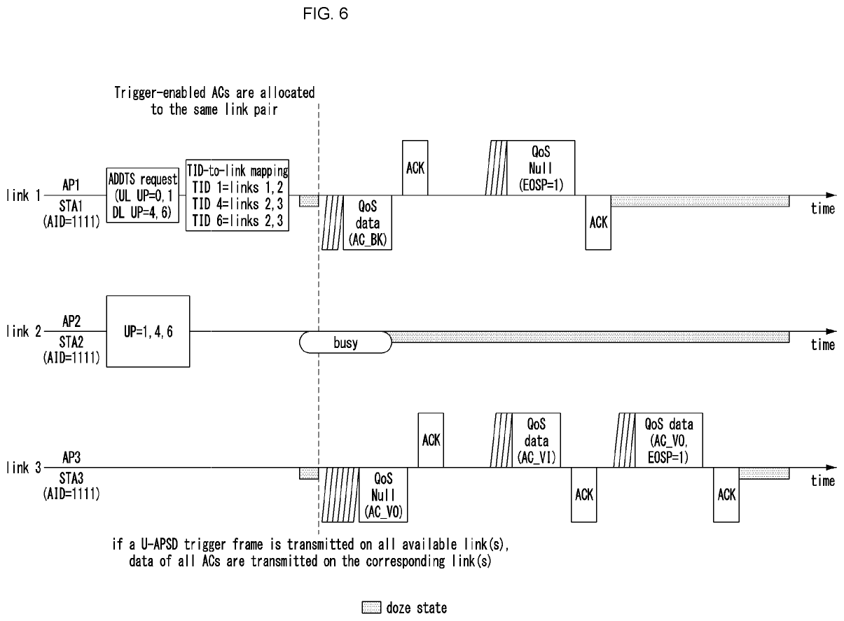

FIG. 6 is a timing diagram illustrating a fourth exemplary embodiment of a U-APSD low-power operation on a multi-link.

As shown in FIG. 6, an AP MLD and a STA MLD may perform an association procedure on one link of a multi-link. The AP MLD and the STA MLD may perform a multi-link setup procedure on one link of a multi-link. Links supported between the AP MLD and the STA MLD may be negotiated through the multi-link setup procedure. Therefore, communication using a multi-link may be performed between the AP MLD and the STA MLD.

The AP MLD and the STA MLD may perform a TSPEC configuration procedure including U-APSD configuring on one link of the multi-link. The TSPEC configuration procedure may be performed through transmission and reception of an ADDTS request frame, ADDTS reserve request frame, ADDTS response frame, and/or ADDTS reserve response frame including a TSPEC element. In the exemplary embodiment of FIG. 6, a UL UP set (e.g., mapped) to 0 (AC_BE), UL UP set (e.g., mapped) to 1 (AC_BK), DL UP set (e.g., mapped) to 4 (AC_VI), and DL UP set (e.g., mapped) to 6 (AC_VO) may be configured. The UL UP set to 0 (AC_BE), UL UP set to 1 (AC_BK), DL UP set to 4 (AC_VI), and DL UP set to 6 (AC_VO) may be configured as being supported in the U-APSD low-power operation. The mapping relationship between UP and AC may be as shown in Table 1, and the values of TID (e.g., 0 to 7) may be the same as the values of UP (e.g., 0 to 7). The mapping relationship between the values of TID and ACs may be the same as the mapping relationship between UP and AC defined in Table 1. Alternatively, the values of TID may be set differently from the values of UP. For example, the TIDs and the ACs may be mapped differently from the values of UP.

The AP MLD and the STA MLD may perform a TID-to-link mapping procedure on one link of the multi-link. In the TID-to-link mapping procedure, link(s) negotiated in the multi-link setup procedure may be mapped to a specific TID. Since TIDs are mapped to ACs, when a specific TID is mapped to a specific link, it may be determined through which link a data unit with which AC is transmitted and received. In the exemplary embodiment of FIG. 6, a TID 1 (AC_BK) may be mapped to links 1 and 2, a TID 4 (AC_VI) may be mapped to links 2 and 3, and a TID 6 (AC_VO) may be mapped to the links 2 and 3. A TID 0 (AC_BE), which is not mapped to a link, may be implicitly interpreted as being mapped to all links. In other words, a TID 0 (AC_BE) may be automatically mapped to all links without a separate configuration procedure.

When a U-APSD low-power operation is configured, the STA MLD may transmit a U-APSD trigger frame to initiate a transmission operation according to the U-APSD low-power operation. When the STA MLD has a data unit to transmit, and an AC of the data unit is mapped to U-APSD, the STA MLD may transmit a QoS data frame or QoS Null frame that is a U-APSD trigger frame. That is, the QoS data frame or QoS Null frame may perform a role (e.g., function) of a U-APSD trigger frame. The U-APSD trigger frame may be transmitted on one or more links among links to which a TID of the data unit is mapped. In the exemplary embodiment of FIG. 6, the AC of the data unit may be AC_BK, AC_BK may be associated with the TID 1, and the TID 1 may be mapped to the links 1 and 2. That is, AC_BK may be mapped to the links 1 and 2.

The STA MLD may select the link 1 among the links (e.g., link 1 and link 2) mapped to AC_BK, and may transmit a QoS data frame of AC_BK, which is a U-APSD trigger frame, on the link 1. The APT may receive a U-APSD frame (e.g., QoS data frame of AC_BK) from the STAT on the link 1.

The STA MLD may not know which AC's BU the AP MLD has. Therefore, when the STAT of the STA MLD transmits the QoS data frame, which is a U-APSD trigger frame, on the link 1, the STA MLD may transmit the U-APSD trigger frame on all available links. For example, if the available links of the multi-link are the links 1 and 3, the STA3 of the STA MLD may transmit the QoS data frame (e.g., QoS data frame including the BU of AC_VO) that is a U-APSD trigger frame on the link 3. The U-APSD trigger frame may not be transmitted on a link that is in a busy state. That is, the link 2, which is in a busy state, may not be an available link. The available link(s) may be the remaining link(s) excluding link(s) in a busy state among the multiple links established between the AP MLD and the STA MLD.

Even when there is no link to which U-APSD for uplink communication is mapped or when there is no data unit to be transmitted to the AP, the STA may transmit a QoS Null frame. On the link, an SP (e.g., U-APSD SP) may start from a time of transmitting the U-APSD trigger frame. The AP(s) of the AP MLD may receive the U-APSD trigger frame from the STA(s) and may transmit data frame(s) including a BU on the link on which the U-APSD trigger frame has been received. When there is no BU to transmit on the link on which the U-APSD trigger frame is received, the AP may terminate the SP by transmitting a QoS Null frame including an EOSP set to 1.

The exemplary embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those who are skilled in the field of computer software.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

In the present specification, unless particularly stated otherwise, a singular expression includes a plural expression unless the context clearly indicates otherwise.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. A method of a first device, the method comprising:
performing, by a processor, a power saving (PS) configuration procedure with a second device;
generating, by the processor, a first frame including a first data unit to initiate a transmission operation according to the PS configuration procedure; and
transmitting, by the processor, the first frame to the second device on a first link of a multi-link configured between the first device and the second device, the first link being mapped to the first data unit.

2. The method of claim 1, further including: performing a mapping procedure of traffic identifier (TID)-to-link mapping with the second device, wherein a first access category (AC) of the first data unit is mapped to a first TID, and the first link is determined based on a mapping relationship between the first AC and the first TID and a relationship of the TID-to-link mapping.

3. The method of claim 1, wherein the first device includes a plurality of stations (STAs), and a state of a first STA operating on the first link among the plurality of STAs transitions from a doze state to a wake-up state for transmission of the first frame.

4. The method of claim 1, wherein the first frame is a quality of service (QoS) data frame that serves as an unscheduled-automatic power save delivery (U-APSD) trigger frame.

5. The method of claim 1, wherein a duration field included in the first frame indicates a time including a time required for transmission and reception of a reception response frame for the first frame and a time required for transmission and reception of a second data frame including information indicating a second AC of a second data unit present in the second device.

6. The method of claim 5, wherein the information is a bitmap, and each bit included in the bitmap indicates presence or absence of a data unit associated with an AC.

7. The method of claim 5, further including:
receiving the second frame from the second device on the first link; and
identifying a second link of the multi-link, which is mapped to the second AC indicated by the second frame,
wherein a state of a second STA operating on the second link among the plurality of STAs included in the first device transitions from a doze state to a wake-up state after a time of receiving the second frame.

8. The method of claim 7, further including: receiving a third frame including the second data unit from the second device on the second link, wherein a reception operation of the third frame is performed within a U-APSD service period (SP) that starts after the time of receiving the second frame.

9. The method of claim 1, wherein a U-APSD SP for the first link or a U-APSD SP for the multi-link starts at a time of transmitting the first frame.

10. The method of claim 9, wherein states of a plurality of STAs included in the first device supporting the multi-link transition from a doze state to a wake-up state at a time at which the U-APSD SP for the multi-link starts.

11. The method of claim 1, further including:
generating a fourth frame including a third data unit to initiate a transmission operation according to the PS configuration procedure; and
transmitting the fourth frame to the second device on a third link of the multi-link, the third link being mapped to the third data unit.

12. The method of claim 11, wherein the first link and the third link are available links excluding busy link(s) of the multi-link.

13. A first device comprising:
a processor; and
a memory configured for storing one or more instructions executable by the processor,
wherein the one or more instructions are executed to perform:
performing a power saving (PS) configuration procedure with a second device;
generating a first frame including a first data unit to initiate a transmission operation according to the PS configuration procedure; and
transmitting the first frame to the second device on a first link of a multi-link configured between the first device and the second device, the first link being mapped to the first data unit.

14. The first device of claim 13, wherein the one or more instructions are further executed to perform: performing a mapping procedure of traffic identifier (TID)-to-link mapping with the second device, wherein a first access category (AC) of the first data unit is mapped to a first TID, and the first link is determined based on a mapping relationship between the first AC and the first TID and a relationship of the TID-to-link mapping.

15. The first device of claim 13, wherein the first device includes a plurality of stations (STAs), and a state of a first STA operating on the first link among the plurality of STAs transitions from a doze state to a wake-up state for transmission of the first frame.

16. The first device of claim 13, wherein a duration field included in the first frame indicates a time including a time required for transmission and reception of a reception response frame for the first frame and a time required for transmission and reception of a second data frame including information indicating a second AC of a second data unit present in the second device.

17. The first device of claim 16, wherein the one or more instructions are further executed to perform:
receiving the second frame from the second device on the first link; and
identifying a second link of the multi-link, which is mapped to the second AC indicated by the second frame,
wherein a state of a second STA operating on the second link among the plurality of STAs included in the first device transitions from a doze state to a wake-up state after a time of receiving the second frame.

18. The first device of claim 13, wherein a U-APSD SP for the first link or a U-APSD SP for the multi-link starts at a time of transmitting the first frame.

19. The first device of claim 18, wherein states of a plurality of STAs included in the first device supporting the multi-link transition from a doze state to a wake-up state at a time at which the U-APSD SP for the multi-link starts.

20. The first device of claim 13, wherein the one or more instructions are further executed to perform:
generating a fourth frame including a third data unit to initiate a transmission operation according to the PS configuration procedure; and
transmitting the fourth frame to the second device on a third link of the multi-link, the third link being mapped to the third data unit,
wherein the first link and the third link are available links excluding busy link(s) of the multi-link.
